(19) United States
(12) Patent Application Publication
(10) Pub. No.: US 2004/0177195 A1
(43) Pub. Date: Sep. 9, 2004

(54) Virtual SCSI enclosure services

(75) Inventors: Patrick Allen Buckland, Austin, TX (US); Lee Dale Cleveland, West Concord, MN (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/371,000

(22) Filed: Feb. 20, 2003

(51) Int. Cl. G06F 13/00

(52) U.S. Cl. 710/300

(57) ABSTRACT

A SCSI adapter uses firmware to provide functionality of a SCSI enclosure services device. In a preferred embodiment, a SCSI adapter communicates with a backplane via I2C IO ports on both the adapter and the backplane. The I2C IO ports of the adapter and backplane are connected via wires of the SCSI connection. Commands sent by applications to the enclosure services device are responded to by the virtual enclosure device. The process is preferably transparent to calling applications.

### BACKGROUND OF THE INVENTION

1. Technical Field

The present invention relates generally to computer peripheral access, particularly to SCSI (Small Computer System Interface) enclosure services.

2. Description of Related Art

SCSI, or Small Computer System Interface, is a general purpose interface used to connect many types of devices to a computer. This interface is popular for attaching high-speed disk drives to high performance computers, such as workstations or network servers. SCSI is not only a disk interface, but is also a system-level interface allowing many types of devices to be connected to a system, as many as seven or fifteen total devices.

When implemented in a SCSI system, hot swapping enables SCSI devices to be added or removed while the system is running. This enables one to more easily connect or reconfigure external peripherals, such as hard disk drives, backup tapes, and CD-ROMs, for example.

Hot swap support is typically provided in a SCSI system by a SCSI Enclosure Services device, or SES device. The SES device is a SCSI bus target that is typically mounted on a SCSI hot swap backplane. The SES device communicates with applications via SCSI commands, and can provide important information, such as how many slots exist on the back plane, the SCSI ID of all slots, whether a slot is populated by a device, or if a slot is powered up or down. The application can then use the SES device, using SCSI commands, to set slots in multiple different modes. Such modes typically include Normal, Identify, Insert, Remove, or Fault.

An SES device typically resides on the backplane itself, and communicates to applications through a SCSI adapter. From the perspective of the PC as a whole, SCSI host adapters are expansion devices, since they plug into a system bus and represent a peripheral device on the system bus. (Some motherboards have integrated SCSI host adapter chips, but these are logically similar to separate host adapters even if no distinct physical card is used.) Host adapters typically require several different system resources, depending on the system bus that the host adapter is designed for, and the method it uses for transferring data over the system bus.

Existing SES approaches have high initial cost for implementation, with only incremental costs incurred for adding more devices. However, disk form factors are continually shrinking in the industry, and along with them space for SCSI bus target SES modules. Current systems cannot be scaled down to few devices cheaply.

Therefore, there is a need in the art for a system and method of implementing enclosure services that overcomes these deficiencies.

### SUMMARY OF THE INVENTION

The present invention includes a computer system with a SCSI adapter and a backplane for peripheral devices. In a preferred embodiment, the SCSI adapter includes firmware or code that provides the functionality of a SCSI enclosure services device by creating a virtual SES device. Commands sent to the enclosure services device are responded to by the virtual adapter.

In preferred embodiments, the present invention takes advantage of low cost IO ports on an adapter chip. The low cost ports communicate with the backplane via the SCSI connector. In one embodiment, the ports on the adapter are I2C IO ports, and similar ports are added to the backplane to facilitate communication.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a computer system consistent with implementing a preferred embodiment of the present invention.

FIG. 2 shows a diagram of a computer system employing a SCSI enclosure device.

FIG. 3 is a block diagram of a prior art SCSI Enclosure Services Device setup.

FIG. 4 is a diagram of prior art backplane with SES.

FIG. 5A shows a diagram of a computer system implementing the Virtual SCSI Enclosure Services of the present invention.

FIG. 5B shows a detail of the adapter and its connections in a preferred embodiment.

FIG. 6 shows a diagram of a backplane implementing the Virtual SES of the present invention.

FIG. 7 shows a flow chart depicting steps for operation of the present invention.

### DETAILED DESCRIPTION OF THE PREFERRED EMBODIMENT

The preferred embodiments of the present invention are described with reference to the figures.

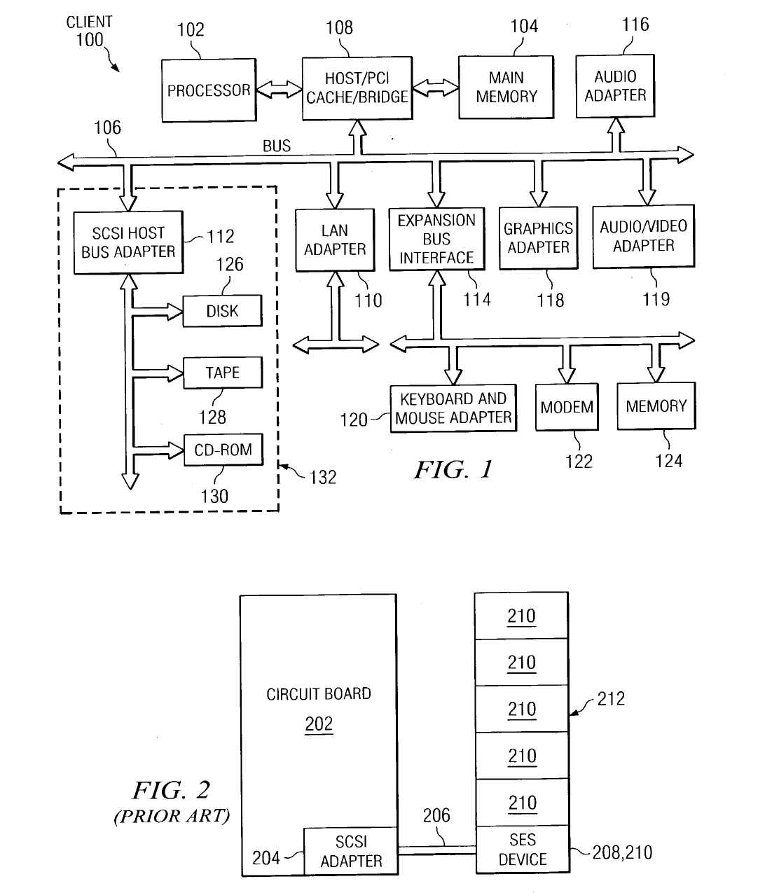

FIG. 1 shows a computer system consistent with implementing a preferred embodiment of the present invention. Data processing system 100 is an example of a computer in which code or instructions implementing the processes of the present invention may be located. Data processing system 100 employs a peripheral component interconnect (PCI) local bus architecture. Although the depicted example employs a PCI bus, other bus architectures such as Accelerated Graphics Port (AGP) and Industry Standard Architecture (ISA) may be used. Processor 102 and main memory 104 are connected to PCI local bus 106 through PCT bridge 108. PCI bridge 108 also may include an integrated memory controller and cache memory for processor 102. Additional connections to PCI local bus 106 may be made through direct component interconnection or through add-in boards. In the depicted example, local area network (LAN) adapter 110, small computer system interface SCSI host bus adapter 112, and expansion bus interface 114 are connected to PCI local bus 106 by direct component connection. In contrast, audio adapter 116, graphics adapter 118, and audio/video adapter 119 are connected to PCI local bus 106 by add-in boards inserted into expansion slots. Expansion bus interface 114 provides a connection for a keyboard and mouse adapter 120, modem 122, and additional memory 124. SCSI host bus adapter 112 provides a connection for hard disk drive 126, tape drive 128, and CD-ROM drive 130. Typical PCI local bus implementations will support three or four PCI expansion slots or add-in connectors.

An operating system runs on processor 102 and is used to coordinate and provide control of various components within data processing system 100 in FIG. 1. The operating system may be a commercially available operating system such as Windows 2000, which is available from Microsoft Corporation. An object oriented programming system such as Java may run in conjunction with the operating system and provides calls to the operating system from Java programs or applications executing on data processing system 100. “Java” is a trademark of Sun Microsystems, Inc. Instructions for the operating system, the object-oriented programming system, and applications or programs are located on storage devices, such as hard disk drive 126, and may be loaded into main memory 104 for execution by processor 102.

Those of ordinary skill in the art will appreciate that the hardware in FIG. 1 may vary depending on the implementation. Other internal hardware or peripheral devices, such as flash ROM (or equivalent nonvolatile memory) or optical disk drives and the like, may be used in addition to or in place of the hardware depicted in FIG. 1. Also, the processes of the present invention may be applied to a multiprocessor data processing system.

For example, data processing system 100, if optionally configured as a network computer, may not include SCSI host bus adapter 112, hard disk drive 126, tape drive 128, and CD-ROM 130, as noted by dotted line 132 in FIG. 1 denoting optional inclusion. In that case, the computer, to be properly called a client computer, must include some type of network communication interface, such as LAN adapter 110, modem 122, or the like. As another example, data processing system 100 may be a stand-alone system configured to be bootable without relying on some type of network communication interface, whether or not data processing system 100 comprises some type of network communication interface. As a further example, data processing system 100 may be a personal digital assistant (PDA), which is configured with ROM and/or flash ROM to provide non-volatile memory for storing operating system files and/or user-generated data.

The depicted example in FIG. 1 and above-described examples are not meant to imply architectural limitations. For example, data processing system 100 also may be a notebook computer or hand held computer in addition to taking the form of a PDA. Data processing system 100 also may be a kiosk or a Web appliance.

The processes of the present invention are performed by processor 102 using computer implemented instructions, which may be located in a memory such as, for example, main memory 104, memory 124, or in one or more peripheral devices 126-130.

FIG. 2 shows a diagram of a prior art computer system employing a SCSI enclosure device. In this example, the computer system includes a circuit board or mother board 202 with a SCSI adapter chip 204. The SCSI adapter 204 provides communication between devices connected to the SCSI bus and applications that call those devices. The adapter 204 is attached via a SCSI cable 206 to a SCSI Enclosure Services device 208, which is located in a backplane 212 capable of receiving multiple peripheral devices in the several slots 210. The purpose of the SES is to provide hotswap capability for devices attached to the backplane 212. The backplane 212 includes an SES device 208 mounted in one of its slots 210. The SES device 208 is a SCSI bus target that communicates via SCSI commands to applications, providing information about the status and population of the slots in the backplane.

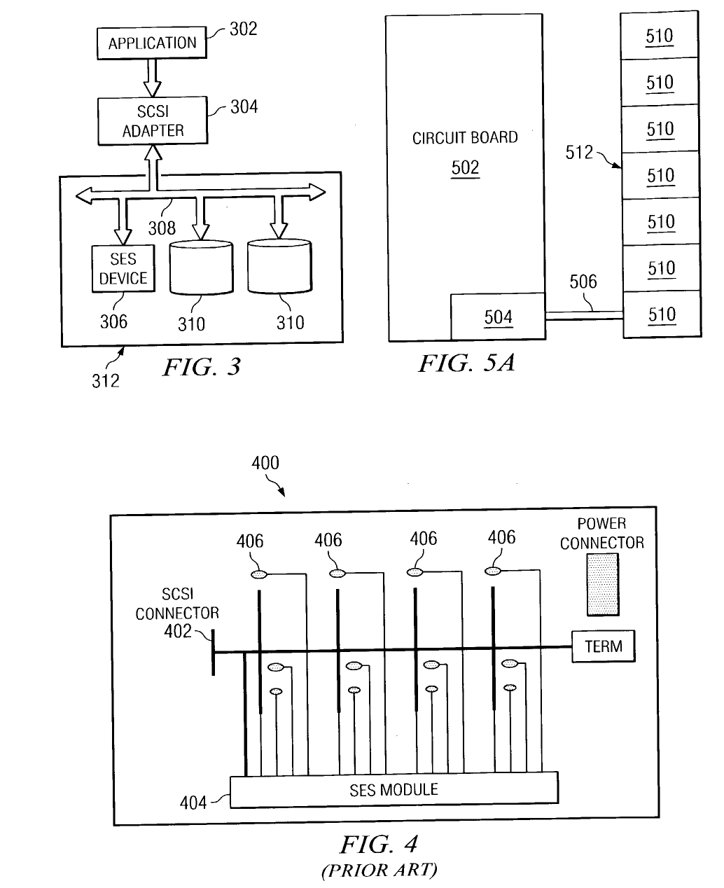

FIG. 3 shows a conceptual diagram of a prior art SES device setup. An application 302 residing in the computer system's storage communicates to peripheral devices 310 attached to the backplane 312 via the SCSI adapter 304. The adapter 304 communicates via bus 308 with SES device 306 using SCSI commands.

FIG. 4 shows a prior art SES backplane 400. The backplane 400 includes SCSI connector 402, SES device 404 on the backplane, the SES device being connected to report the population of devices in any slot 406 and to control LEDs on each slot that is visible to the user of the backplane.

The SCSI connector 402 is connected to communicate with a SCSI adapter (not shown). The adapter sends commands to and from applications to communicate with devices in the backplane via the SES module 404.

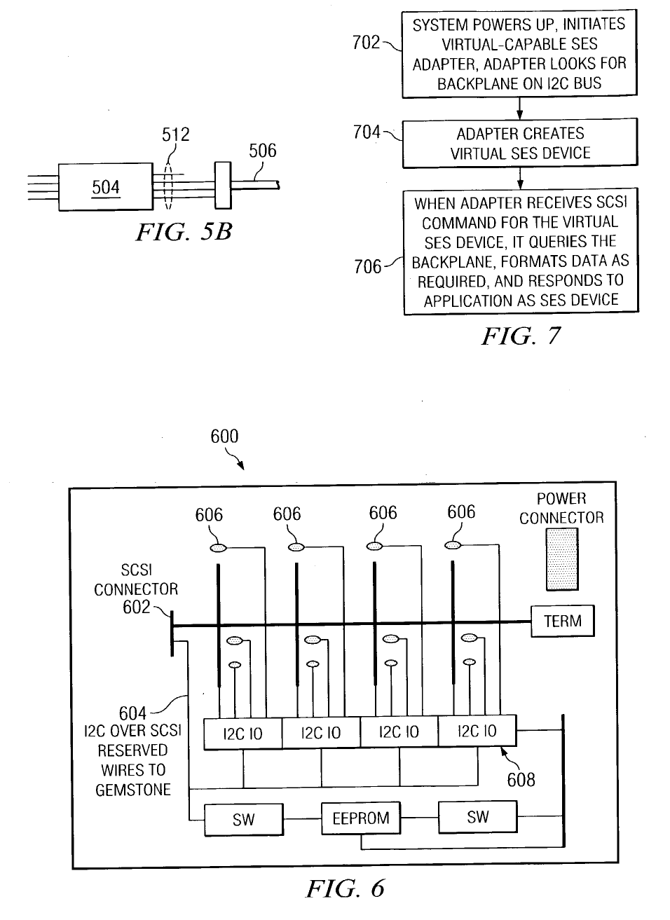

FIG. 5A shows a diagram of a computer system implementing the virtual SES of the present invention. In a preferred embodiment, motherboard or circuit board 502 includes a SCSI adapter chip 504 that includes an internal microprocessor (not shown) that runs the higher level functions of the adapter. The adapter chip 504 includes a low cost IO port (I2C in this example). The I2C (Inter-IC) bus is a bi-directional two-wire serial bus that provides a communication link between integrated circuits (ICs). The chip 504 is also connected to the backplane 512 by SCSI cable 506. The I2C bus in this example uses the two reserved pins in the SCSI cable so that no extra cabling is required.

The adapter 504 also includes special code for implementing the virtual SES, as described further below. The adapter uses the IO port in conjunction with the code to provide the same level of function to applications as prior art SCSI Enclosure Services, but without the need for a separate enclosure device attached to the backplane.

At power on, virtual SES adapter looks for the virtual SES backplane on the I2C bus formed using the additional I2C IO ports of the adapter chip. If a backplane is found, the adapter reads some backplane configuration data stored in an EEPROM on the backplane (also I2C attached) to create a virtual SES device that an application can use to communicate with devices attached to the backplane. When the adapter receives a SCSI command for the virtual SES, it queries the backplane via the two I2C IO ports, formats the data as required and then responds as an SES device to the adapter connected to the backplane. The application sees the same results as if it were talking to a real SES device, but the commands are now operated on by the adapter instead of a physical SES device in the backplane.

FIG. 5B shows a detail of the adapter chip 504 and the connection to the SCSI cable 506. Adapter 504 includes, in a preferred embodiment, a low cost IO bus (I2C in this example) 512 which use spare wires of SCSI cable 506. The wires connected to the I2C ports are connected at the backplane to IO port expanders that monitor each slot of the backplane and control LEDs for each slot of the backplane, allowing the adapter chip to monitor the population of each slot on the backplane and to provide controllable indicators for each slot on the backplane.

FIG. 6 shows a backplane 600 consistent with implementing a preferred embodiment of the present invention. Innovative backplane 600 includes SCSI connector 602 with an I2C connection 604 made between devices on the backplane 600 and the SCSI adapter chip (not shown) using reserved wires of the SCSI connector 602. Each slot 606 of the innovative backplane 600 has an independent I2C IO connection 608, allowing the adapter chip, using added code, to perform the functions of an SES device. An application communicating with the backplane can communicate with the virtual SES device in the SCSI adapter instead of communicating with a physical SES device. The virtual SES reports backplane configuration (such as number of slots, their SCSI IDs, backplane part number, etc.), monitors and reports slot population, controls slot LEDs (via SES commands), can control slot power, and can report general power and cooling status as well. In a preferred embodiment, all of these functions appear to an application as if they were performed by a physical SES device, so implementation of the virtual SES device is preferably transparent to applications.

Though the innovative backplane is described with reference to I2C IO ports, the idea of the present invention is not meant to be limited by this particular implementation detail. For example, other types of bus or connection between the adapter and the backplane are consistent with the present invention.

FIG. 7 shows a flow chart for implementing a preferred embodiment of the present invention. In this example implementation, the system powers up, initiating the virtual-capable SCSI adapter to look for an SES backplane on the I2C bus (step 702). If a backplane is found, the adapter creates a virtual SES device (preferably implemented as firmware or code in the adapter) for applications to use in communicating with the backplane (step 704). When the adapter receives a SCSI command for the virtual SES device, it queries the backplane via the I2C IO ports, formats the data as required, and then responds to the application as an SES device (step 706). In preferred embodiments, this process is transparent to the calling application. This process allows the application to send SCSI commands for the SES device to the adapter, and the application sees the same results as if it were talking to a physical SES device on the backplane. However, the commands are now operated on by the adapter instead of a physical SES device on the backplane.

In less preferred embodiments, the virtual enclosure services device is created using code not on board the SCSI adapter.

The current innovations allow the replacement of the enclosure services device with a bit of firmware and a modified backplane capable of connection via I2C IO ports. The modified adapter and backplane are also capable of implementing a plurality of communication standards for SCSI, such as ANSI and SAF-TE, merely by adding or modifying code. Thus, compatibility with such standards is cheaper and more easily implemented than in prior art systems.

The innovative system disclosed herein has several advantages over prior art systems. While prior art SES systems have a high initial cost but small incremental costs for added devices, the present approach can be scaled to very few devices cheaply, without incurring the cost of a physical enclosure services device. This advantage grows in importance as disk form factors shrink, as well as backplanes, and allows conservation of space on backplanes. Timing budgets on device backplanes are also becoming more sensitive. The present invention removes a critical but low use function from the high speed bus, simplifying design and bus analysis.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer system, comprising:
a Small Computer System Interface (SCSI) adapter;
a backplane connected to communicate with the adapter;
wherein the adapter provides the functions of a SCSI enclosure services device.

2. The system of claim 1, wherein the adapter provides the functions of a SCSI enclosure services device by creating a virtual SCSI enclosure services device.

3. The system of claim 2, wherein the adapter provides the functions of a SCSI enclosure services device by creating the virtual SCSI enclosure services device using the adapter's firmware.

4. The system of claim 1, wherein the adapter communicates with the backplane via I2C IO ports, the ports being connected to the backplane via a SCSI connection.

5. The system of claim 1, wherein the virtual SCSI enclosure services device appears as a physical SCSI enclosure services device to an application.

6. A method of controlling devices on a Small Computer System Interface (SCSI), comprising the steps of:
initiating a SCSI adapter capable of communicating with a backplane; and
creating a virtual SCSI enclosure services device.

7. The method of claim 6, wherein the virtual SCSI enclosure services device is implemented as code in the SCSI adapter.

8. The method of claim 6, wherein the virtual SCSI enclosure services device appears as a physical device to an application.

9. The method of claim 6 wherein the adapter communicates with the backplane via I2C IO ports, the ports connected to the backplane via a SCSI connection.

10. A computer system, comprising:
an application on the computer system, the application being able to communicate with a backplane through a Small Computer System Interface (SCSI) adapter
a microprocessor that runs at least some functions of the adapter;
code which allows the adapter to provide enclosure services for the backplane.

11. The system of claim 10, wherein the adapter includes I2C IO ports which are connected to I2C IO ports located on the backplane.

12. The system of claim 10, wherein the code which allows the adapter to provide enclosure services for the backplane is firmware in the adapter.

13. The system of claim 10, wherein the adapter provides enclosure services by creating a virtual SCSI enclosure services device.

14. The system of claim 13, wherein the virtual SCSI enclosure services device appears as a physical SCSI enclosure services device to an application.

15. An improved Small Computer System Interface (SCSI) adapter, wherein the improvement comprises:
code associated with the adapter which creates a virtual SCSI enclosure services device.

16. The improved SCSI adapter of claim 15, wherein when the adapter receives a command for an enclosure services device, the adapter responds to the command as an enclosure services device.

17. The improved SCSI adapter of claim 15, wherein when the adapter receives a command for an enclosure services device, the adapter queries a backplane, formats data, and responds to the command as an enclosure services device.

18. The improved SCSI adapter of claim 15, wherein the adapter includes I2C IO ports connected to a backplane via a SCSI connection.

19. A computer system, comprising:
a backplane connected to an adapter by a small computer system interface (SCSI) connector, the backplane having a plurality of slots;
wherein at least some of the slots of the backplane include ports connected to the adapter via the SCSI connector; and
wherein the adapter provides enclosure services to the backplane.

20. The system of claim 19, wherein the ports are I2C IO ports.

21. The system of claim 19, wherein the adapter provides enclosure services by creating a virtual enclosure services device.
